(19) United States
(12) Patent Application Publication
(10) Pub. No.: US 2013/0260234 A1
(43) Pub. Date: Oct. 3, 2013

(54) LITHIUM BATTERY CATHODE HAVING PROTECTIVE FILM MADE UP OF INORGANIC PARTICLES AND LITHIUM BATTERY

(71) Applicants: BOR-YUAN HSIAO, Tu-Cheng (TW); CHENG-CHUNG CHIU, Tu-Cheng (TW); CHIEN-FANG HUANG, Tu-Cheng (TW)

(72) Inventors: BOR-YUAN HSIAO, Tu-Cheng (TW); CHENG-CHUNG CHIU, Tu-Cheng (TW); CHIEN-FANG HUANG, Tu-Cheng (TW)

(73) Assignees: UER TECHNOLOGY CORPORATION, Miaoli County (TW); UER TECHNOLOGY (SHENZHEN) LIMITED, ShenZhen (CN)

(21) Appl. No.: 13/584,765

(22) Filed: Aug. 13, 2012

(30) Foreign Application Priority Data
Mar. 28, 2012 (TW) 101110707

(51) Int. Cl. H01M 4/64; B82Y 30/00

(52) U.S. Cl. 429/211; 977/755

(57) ABSTRACT

A longer-lasting lithium battery cathode includes a current collector, a cathode active material layer, and a protective film. The cathode active material layer is coated on the current collector. The protective film layer is coated on the cathode active material layer, and the protective film layer consists of inorganic particles.

### BACKGROUND

1. Technical Field

The present disclosure relates to lithium batteries and, particularly, to a lithium battery having steady capacity.

2. Description of Related Art

Lithium batteries are widely used in consumer electronic devices such as mobile phones and note-book computers. A typical lithium battery includes a cathode, an anode, an electrolyte, and an isolating film. The cathode includes a current collector and a cathode active material layer coated on the current collector. However, high temperatures may cause the cathode active material to be dissolved in the electrolyte, and this reduces the capacity of the lithium battery.

Therefore, a lithium battery cathode and a lithium battery which can overcome the above-mentioned problems are needed.

### BRIEF DESCRIPTION OF THE DRAWINGS

FIG. 1 is a schematic view of a lithium battery cathode according to a first embodiment.

FIG. 2 is a schematic view of a lithium battery according to a second embodiment, the lithium battery including the lithium battery cathode of FIG. 1.

FIGS. 3 and 4 are curve diagrams, showing the result of charge-discharge testing on lithium batteries.

### DETAILED DESCRIPTION

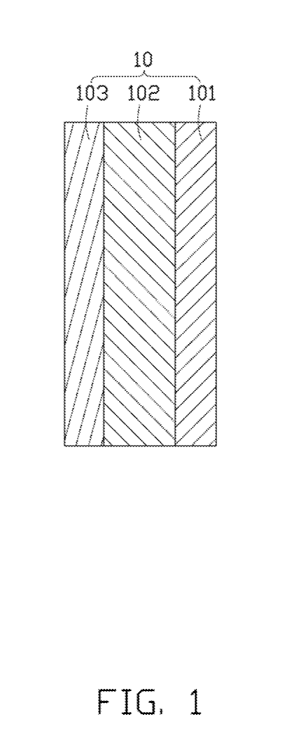

Referring to FIG. 1, a lithium battery cathode 10 according to a first embodiment is shown. The lithium battery cathode 10 includes a current collector 101, a cathode active material layer 102, and a protective film 103. The current collector 101 is made of metal or carbon and has good electric conductivity. In this embodiment, the current collector 101 is copper foil. The cathode active material layer 102 is made of carbon material, or transition metal, or a transition metal oxide, such as graphite, carbon fiber, carbon nanotubes, tin, and tin oxide. The cathode active material layer 102 is coated on the current collector 101. The protective film 103 is made up of inorganic particles. The inorganic particles may have their origin in metal, silicon, metal oxide, or silicon oxide, such as Ag, Cu, Sn, Al, Wu, Si, SiOx (0<x≦2), SiOx-graphite(0<x≦2), and SiOx-carbon(0<x≦2). The thickness of the protective film 103 is less than 100 nanometers.

The protective film 103 is coated on the cathode active material layer 102 by means of an evaporation or sputtering process. When coating, micropores are formed in the protective film 103 as the inorganic particles have irregular shapes. Electrolyte can pass through the micropores of the protective film 103.

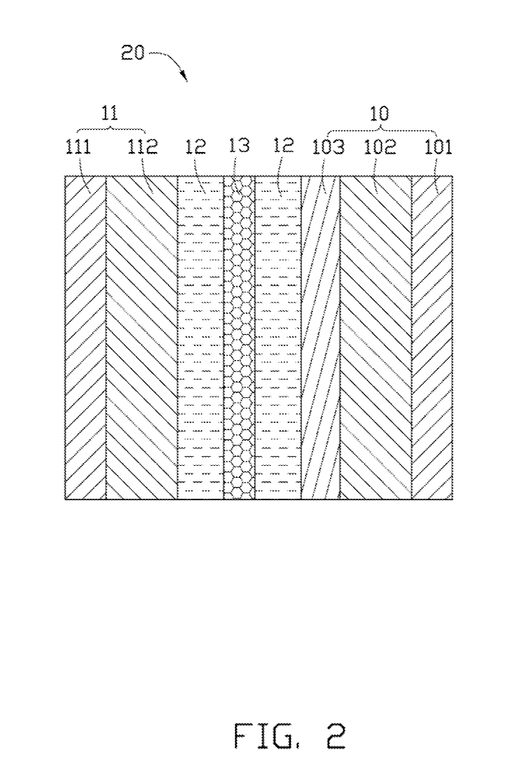

Referring to FIG. 2, a lithium battery 20 according to a second embodiment is shown. The lithium battery 20 includes an anode 11, an electrolyte 12, an isolating film 13, and the cathode 10 of the first embodiment.

The anode 11 includes a current collector 111 and an anode active material layer 112 coated on the current collector 111. The anode active material layer 112 is made from composite oxides of lithium and a transition metal, such as lithium manganese oxide, lithium nickel oxide, and lithium cobalt oxide. The electrolyte 12 is an organic electrolytic solution composed of an organic solution containing lithium salt. The organic solution is propylene carbonate, glycol carbonate, dimethyl carbonate, or the like. The lithium salt is lithium perchlorate, lithium tetrafluoroborate, lithium hexafluorophosphate, or the like.

The isolating film 13 is made from inorganic paper which is non-woven, or from microporous polymeric membranes.

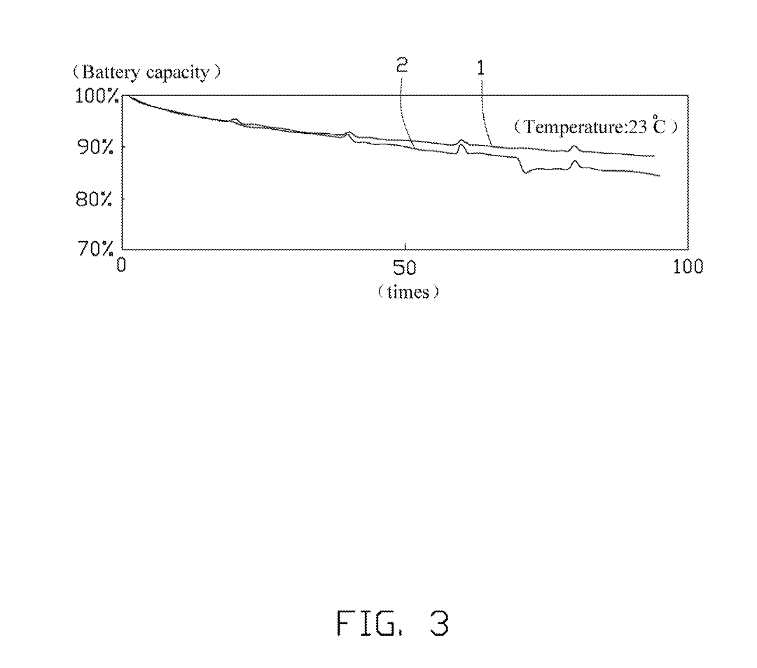

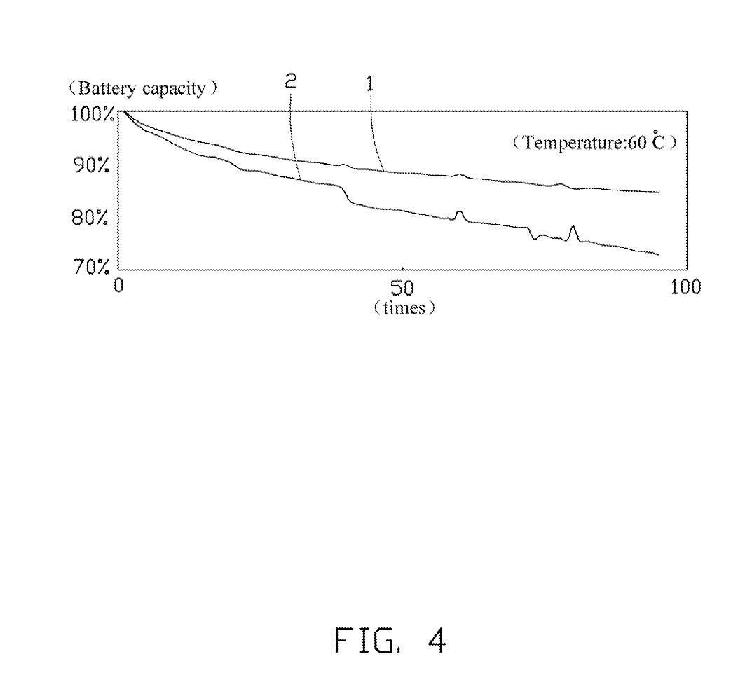

FIGS. 3 and 4 show the result of charge-discharge testing on lithium batteries. A curve 1 shows the result of the test on the lithium battery 20 having the protective film 103. A curve 2 shows the result of the test on a lithium battery without the protective film 103. FIG. 3 shows the test executed under a temperature of 23 degrees Celsius (C). FIG. 4 shows the test executed under a temperature of 60 degrees C. FIGS. 3 and 4 show that after a number of charge-discharge tests, the capacity of the lithium battery 20 having the protective film 103 is higher than the capacity of the battery without the protective film 103, and the difference between the capacities of the two batteries is significant and more apparent at the higher temperatures. It is clear from FIGS. 3 and 4 that the protective film 103 prevents the cathode active material 102 from being dissolved in the electrolyte 12 and stabilizes the capacity of the lithium battery, thus significantly extending the life of the lithium battery 20.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A lithium battery cathode, comprising:
a current collector;
a cathode active material layer coated on the current collector; and
a protective film coated on the cathode active material layer, the protective film layer consisting of inorganic particles.

2. The lithium battery cathode of claim 1, wherein the protective film is made of at least one selected from the group consisting of metal, silicon, metal oxide, and silicon oxide.

3. The lithium battery cathode of claim 2, wherein the protective film is made of at least one selected from the group consisting of Ag, Cu, Sn, Al, Wu, Si, SiOx, SiOx-graphite, and SiOx-carbon, wherein 0<x≦2.

4. The lithium battery cathode of claim 1, wherein a thickness of the protective film is less than 100 nano-meters.

5. The lithium battery cathode of claim 1, wherein the cathode active material layer is made of at least one selected from the group consisting of carbon material, transition metal, and transition metal oxide.

6. The lithium battery cathode of claim 1, wherein the current collector is made of metal or carbon.

7. A lithium battery, comprising:
an anode;
an electrolyte;
an isolating film; and
a cathode comprising:
a current collector;
a cathode active material layer coated on the current collector; and
a protective film coated on the cathode active material layer, the protective film layer consisting of inorganic particles.

8. The lithium battery of claim 7, wherein the protective film is made of at least one selected from the group consisting of metal, silicon, metal oxide, and silicon oxide.

9. The lithium battery of claim 8, wherein the protective film is made of at least one selected from the group consisting of Ag, Cu, Sn, Al, Wu, Si, SiOx, SiOx-graphite, and SiOx-carbon, wherein 0<x≦2.

10. The lithium battery of claim 7, wherein a thickness of the protective film is less than 100 nano-meters.

11. The lithium battery of claim 7, wherein the cathode active material layer is made of at least one selected from the group consisting of carbon material, transition metal, and transition metal oxide.

12. The lithium battery of claim 7, wherein the current collector is made by metal or carbon.
